(19) United States
(12) Patent Application Publication
(10) Pub. No.: US 2025/0291330 A1
(43) Pub. Date: Sep. 18, 2025

(54) GENERATING FACILITY HEALTH STATUSES FOR A PROCESSING FACILITY

(71) Applicant: Schlumberger Technology Corporation, Sugar Land, TX (US)

(72) Inventors: Mahyar Mohajer, Houston, TX (US); Oleg O. Medvedev, Houston, TX (US); Marcus Ungaretti Rossi, Houston, TX (US); Kiona Y. Meade, Houston, TX (US); Keat Choon Goh, Houston, TX (US); Ben Hewitt, Houston, TX (US); Praprut Songchitruksa, Houston, TX (US); Parag Vasant Karanjkar, Houston, TX (US); Gaojing Cao, Houston, TX (US); Julianna Braga Ferreira, Houston, TX (US)

(21) Appl. No.: 19/078,428

(22) Filed: Mar. 13, 2025

Related U.S. Application Data
(60) Provisional application No. 63/564,572, filed on Mar. 13, 2024.

(51) Int. Cl. G05B 19/406; G05B 13/02

(52) U.S. Cl. CPC G05B 19/406; G05B 13/0265; G05B 2219/32204

(57) ABSTRACT

A health status and monitoring system may receive status information for a plurality of subsystems of the fluid processing facility, the status information including at least one of time-series data, daily reports, maintenance records, inspection records, equipment runtime, equipment uptime, control room reports, shift reports, or laboratory samples. A health status and monitoring system may apply a current status model to the status information, the current status model generating a health status for the fluid processing facility, the health status incorporating a subsystem status of the plurality of subsystems.

### CROSS-REFERENCE TO RELATED APPLICATIONS

The present application claims priority to and the benefit of U.S. Provisional Patent Application Ser. No. 63/564,572 titled “GENERATING FACILITY HEALTH STATUSES FOR AN INDUSTRIAL FACILITY” filed Mar. 13, 2024, the disclosure of which is incorporated herein by reference in its entirety.

### BACKGROUND OF THE DISCLOSURE

Recent years have seen improvements in modeling of various activities, systems, processes, equipment, and behaviors. But such models may be limited to a single system or representation. For example, a particular model may be representative of a particular system. But many industrial systems include an integration of multiple subsystems. For example, a fluid processing facility may utilize multiple systems to process oil and natural gas. The fluid processing facility may have an overall status, which may be a representation of the total health of the fluid processing facility. The overall status may be difficult to determine based on singular models. For example, multiple, synergistic or cascading statuses may impact the fluid processing facility in ways that are not clear based on a singular status of a particular subsystem.

### SUMMARY

In some aspects, the techniques described herein relate to a method for monitoring a health and a performance of a fluid processing facility. A facility health management system generates a plurality of key performance indicators (KPIs) for a plurality of units of equipment. At least two units of equipment of the plurality of units of equipment include different types of equipment. The plurality of key performance indicators are based on status information received for the fluid processing facility. The facility health management system applies a ranking model to the plurality of KPIs. The ranking model generates a plurality of rankings. Each ranking of the plurality of rankings are associated with a unit of equipment of the plurality of units of equipment. Based on the plurality of rankings, the facility health management system prepares a recommendation to perform an action at the fluid processing facility. The facility health management system implements the recommendation at the fluid processing facility.

In some aspects, the techniques described herein relate to a method for monitoring a health and a performance of a fluid processing facility. A facility health management system receives status information for a plurality of units of equipment of the fluid processing facility. At least two of the plurality of units of equipment including different types of equipment. Based on the status information, the facility health management system generates one or more key performance indicators (KPIs) for each of the plurality of units of equipment. The facility health management system applies a ranking model to the one or more KPIs. The ranking model generates a ranking for each of the plurality of units of equipment, the ranking including a comparison between the plurality of units of equipment.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a facility health management system, according to at least one embodiment of the present disclosure.

FIG. 2 is a schematic representation of a facility health management system, according to at least one embodiment of the present disclosure.

FIG. 3 is a schematic representation of an equipment ranking system, according to at least one embodiment of the present disclosure.

FIG. 4 is a representation of a subsystem of a facility including a flow between multiple units of equipment, according to at least one embodiment of the present disclosure.

FIG. 5 is a representation of a flow diagram of a facility health management system, according to at least one embodiment of the present disclosure.

FIG. 6 is a representation of a flow diagram of a facility health management system, according to at least one embodiment of the present disclosure.

FIG. 7 is a flowchart of a method for monitoring a health and a performance of a fluid processing facility, according to at least one embodiment of the present disclosure.

FIG. 8 is a flowchart of a method for monitoring a health and a performance of a fluid processing facility, according to at least one embodiment of the present disclosure.

FIG. 9 is a representation of a computing system, according to at least one embodiment of the present disclosure.

### DETAILED DESCRIPTION

This disclosure generally relates to devices, systems, and methods for a facility health management system for a processing facility. A facility management system may include a framework to monitor the health and performance of a complex processing facility. As a specific, non-limiting example, the processing facility may include a fluids processing facility. For example, the fluids processing facility may include an oil and natural gas processing facility.

Typically, such a facility will be managed by an operations and maintenance team, including multiple highly trained and/or educated technicians and engineers. The operations and maintenance team's prime function may be to monitor the health of the production process and its associated equipment, make adjustments and repairs as the process inlet and outlet conditions and constraints change, and as the equipment in the facilities wear and age with time. The primary challenge for the operations and maintenance team is to identify and address the threats to continued production performance and uptime. But the status of the processing facility may be difficult to identify based on the complex interaction between the various subsystems, sensors, inputs, outputs, and other elements of the processing facility.

In accordance with at least one embodiment of the present disclosure, a facility health management system may receive input information from multiple subsystems and prepare a health status for the equipment of the processing facility. The health status may incorporate the operating state of the various subsystems, sensor information, reports, and other input information. This may allow the operator to identify statuses or processes that are reducing the efficiency of the facility. The operator may then make an adjustment to facility to improve the efficiency. This may help to reduce the operating costs, improve the output, improve the throughput, or otherwise improve the operating of the processing facility.

In some embodiments, the facility health management system may identify a health status ranking for the various units of equipment at the fluid processing facility. For example, the facility health management system may generate key performance indicators (KPIs) that are associated with one or more aspects of the operation and/or maintenance of the equipment or the facility. The KPIs may be used to generate a health status ranking for the units of equipment. For example, each of the KPIs may have an assigned weight that may be combined to generate the health status ranking. The health status rankings of the various units of equipment may then be used to identify the relative health of the unit of equipment. For example, the health status rankings may be used to identify the relative health of the units of equipment with respect to other units of equipment at the processing facility.

In some embodiments, the health status rankings may be used to generate recommendations to adjust at least one operating parameter and/or maintenance action. For example, the unit of equipment having a health status ranking associated with the most pressing or urgent health status may receive a recommendation to adjust an operating parameter and/or perform maintenance. In this manner, the health status rankings may be used to prioritize operational changes and/or prioritize maintenance actions at the processing facility to prevent or reduce equipment-related downtime.

In some embodiments, the facility health management system may implement the recommendation. For example, based on the recommendation, an equipment controller may adjust an operating parameter of at least one unit of equipment, or a maintenance technician may perform maintenance on a unit of equipment. After implementing the recommendation, the facility health management system may generate new KPIs and new health status rankings for the equipment of the processing facility. The facility health management system may then generate a new recommendation, which may include or be associated with an action related to a new unit of equipment. In this manner, the facility health management system may include a feedback loop to improve the operating health of the processing facility based on the most urgent equipment needs.

In accordance with at least one embodiment of the present disclosure, the facility health management system may implement one or more artificial intelligence (AI) and/or machine learning (ML) models. The AI and/or ML models may analyze the status information for the subsystems. The health status and monitoring system may apply the AI and/or ML models to generate the health status for the facility. As discussed herein, the status information may include input data, output data, sensor data, time-series data, daily reports, maintenance records, inspection records, equipment runtime, equipment uptime, control room reports, shift reports, laboratory samples, any other status information, and combinations thereof. In some embodiments, the status information includes structured data, such as highly organized data organized into pre-determined formats, including sensor data, tabular data, report data, and so forth. In some embodiments, the status information includes unstructured data, such as natural language, images, sounds, and other unstructured data having little or no pre-determined format, data type, or value range.

The AI and/or ML models may be trained to analyze a combination of the status information. For example, the AI and/or ML models may be trained to analyze all of, or a subset, of the received status information for the processing facility. In some embodiments, the ML model and/or the current status model may be trained on prior health statuses for the same facility and/or for other facilities. The AI and/or ML models may identify patterns within the status information. These patterns may be associated with various health statuses of the processing facility. This may allow the AI and/or ML models to identify the health status of the processing facility.

For example, the AI and/or ML models may be trained to identify one or more KPIs for the processing facility. For example, an equipment status model may be trained using machine learning techniques to identify, based on received status data from the processing facility, an equipment status. The equipment status may be associated with an operating efficiency, operating anomalies, failure probabilities, and so forth. In some examples, facility alert model may be trained to identify, based on received status data from the processing facility, operating alerts for the processing facility. Such operating alerts may be associated with production data, input flow data, output flow data, and other general facility information. In some embodiments, the operating alerts may be general to the entire facility.

In some examples, a weighting model may include at least a portion that is trained using machine learning techniques to apply weights to various KPIs to generate the rankings. For example, the weighting model may receive, as input, one or more of KPIs, operator-generated weights, recommendations, implemented recommendations, changes in operating conditions, and so forth. The weighting model may utilize insights from the input to adjust the weights of the KPIs. In this manner, the weighting model may facilitate more accurate rankings of the various units of equipment.

As illustrated by the foregoing discussion, the present disclosure utilizes a variety of terms to describe features and advantages of the production facility control system. Additional detail is now provided regarding the meaning of such terms. For example, as used herein, “status” or “status information” refers to condition information associated with a processing facility. For example, status information for the production facility may include a representation of a status of various units of equipment. The status of the units of equipment may include operating, not operating, operating inputs, operating outputs, motor speed, motor energy consumption, pressure, temperature, volumetric flow rate, mass flow rate, fuel consumption, any other status, and combinations thereof, including inclusions or exclusions of any of the foregoing. In some embodiments, the status information includes the status of a single unit of equipment. In some embodiments, the status information includes the individual status of multiple units of equipment. In some embodiments, the status information includes a combination of statuses of units of equipment, including summations or other functions of multiple units of equipment. In some embodiments, the status information may include the overall facility status, including overall processing facility inputs, overall processing facility outputs, processing facility input composition, processing facility output composition, volume of gas sent to flare, total energy consumption, any other overall plant status, and combinations thereof, including inclusions and exclusions of any of the foregoing. In some embodiments, the status information may include maintenance information, such as maintenance reports, maintenance actions performed, preventative maintenance schedule, historical maintenance records, and so forth. The status information may be determined in any manner. For example, the operating state may be determined using sensed conditions using various sensors located at various positions around the production plant. In some examples, the operating state may be estimated at a point in the future, based on measured or predicted changes in the operating state.

As used herein, the term “key performance indicator (KPI)” may refer to status information that has been collected or processed in a way that facilities understanding of an aspect of a unit of equipment. For example, and as discussed in further detail herein, a KPI may include raw status information or processed status information. In some examples, a KPI may include reports or summaries of reports. In some examples, a KPI may include maintenance information, alerts, model output information, and so forth.

As used herein, the term “machine learning” refers to algorithms that generate data-driven predictions or decisions from known input data by modeling high-level abstractions. Examples of machine-learning models include computer representations that are tunable (e.g., trainable) based on inputs to approximate unknown functions. For instance, a machine-learning model includes a model that utilizes algorithms to learn from, and make predictions on, known data by analyzing the known data to learn to generate outputs that reflect patterns and attributes of the known data. For example, machine-learning models include latent Dirichlet allocation (LDA), multi-arm bandit models, linear regression models, classification models, logistical regression models, random forest models, support vector machines (SVMs) models, neural networks (convolutional neural networks, recurrent neural networks such as LSTMs, graph neural networks, etc.), or decision tree models.

A machine learning model may be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some embodiments, a machine learning model may include one or multiple machine learning models that cooperatively generate one or more outputs based on corresponding inputs.

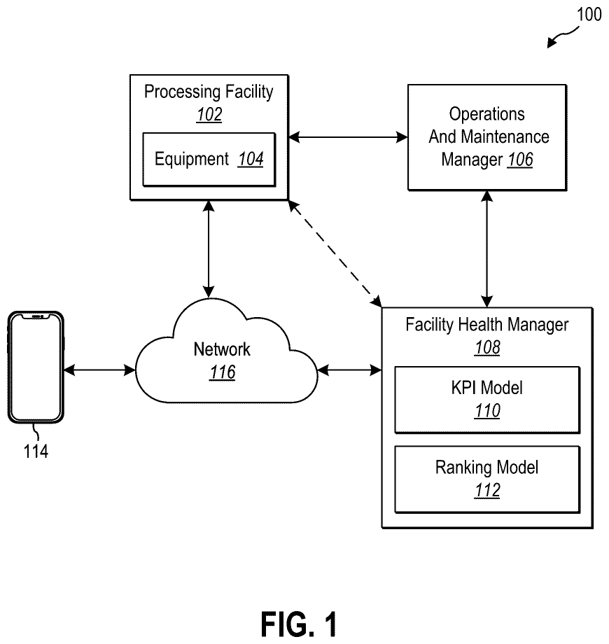

FIG. 1 is a schematic representation of a facility health management system 100, according to at least one embodiment of the present disclosure. The facility health management system 100 may monitor a processing facility 102. The processing facility 102 may include equipment 104. The equipment 104 may include any equipment that may be utilized at an oil and gas processing facility. For example, the equipment 104 may include one or more of fluid handling equipment (e.g., compressors, pumps, valves, piping) separation equipment (e.g., separators, treaters, desalters, vessels, drums), degasification units, purification units, heating and processing equipment (e.g., heat exchangers, heaters, chillers, cooling towers, gas processing units (gas sweetening unit, MEG regeneration unit)), absorbers, strippers, sulfur recovery units, amine contactors, regenerators, vapor recovery units, any other equipment, and combinations thereof. While embodiments of the present disclosure may be related to specific types of equipment, such compressors or banks of compressors in series or in parallel, it should be understood that the techniques of the present disclosure may be applied to any unit or type of equipment.

The facility health management system 100 may further include an operations and maintenance manager 106. The operations and maintenance manager 106 may be in communication with the equipment 104 in the processing facility 102. For example, the operations and maintenance manager 106 may be in communication with the equipment 104 to change the operating status of the equipment 104 and/or manage a maintenance program for the equipment 104. The operations and maintenance manager 106 may change the operating parameters of the equipment 104, such as the various settings, positioning, or other operating parameters of the equipment 104. In some examples, the operations and maintenance manager 106 may change whether a particular unit of equipment 104 is turned on or shut down. In some examples, the operations and maintenance manager 106 may generate or adjust a maintenance schedule, including a preventative maintenance schedule. In some examples, the operations and maintenance manager 106 may generate or adjust a corrective maintenance action or schedule to correct identified problems, breakdowns, or other issues with the equipment 104.

The facility health management system 100 may further include a facility health manager 108. The facility health manager 108 may receive status information from the processing facility 102 regarding the status of various equipment. For example, the facility health manager 108 may receive sensor measurements, reports, model outputs, and so forth that may be associated with the health of the processing facility 102. A KPI model 110 may generate one or more KPIs associated based on the status information. For example, the KPI model 110 may summarize, extract, collate, or otherwise process the status information to generate the KPIs associated with the status information. As discussed in further detail herein, the KPI model 110 may generate the KPIs in any manner. For example, the KPI model 110 may include a model to process the status information. In some embodiments, the KPI model 110 may utilize user input to generate status information.

The facility health manager 108 may further include a ranking model 112. The ranking model 112 may, using the KPIs, generate a health status ranking for the equipment 104 of the processing facility 102. The health status ranking may be an indication of the health status of the equipment 104 based on the KPIs. For example, the health status ranking may be a relative ranking. The relative ranking may be a comparative ranking of the status of the equipment based on the identified KPIs. Utilizing a relative ranking may facilitate maintenance or operational recommendations that may focus on the portion of the processing facility 102 that may most positively impact the processing facility 102, including most positively impact the product, uptime, or other aspect of the processing facility 102.

In accordance with at least one embodiment of the present disclosure, the ranking model 112 may generate rankings for different types of equipment. Providing a ranking for the same type of equipment may be a matter of comparing features of the equipment, which may all be the same or very similar. However, generating rankings for different types of equipment is a non-trivial task. As a specific, non-limiting example, a compressor and a separator may have different inputs, outputs, operating parameters, parts, maintenance schedules, and so forth. Generating a ranking to compare the operation and criticality of the compressor and the separator may be difficult due to these different features.

In according with at least one embodiment of the present disclosure, the ranking model 112 may generate a ranking for different types of equipment by comparatively ranking the KPIs for the equipment. For example, the ranking model 112 may identify the various KPIs generated for the equipment 104, generate a weight for each of the KPIs, and then generate a total ranking based on the weighted KPIs.

The weights of the KPIs may be generated in any manner. For example, as discussed in further detail herein, the ranking model 112 may utilize user input to weigh the different KPIs. Such user input may include a series of pairwise comparisons between KPIs. A weighting model may utilize the pairwise comparisons to generate the weight for each of the KPIs. The weighted KPIs may then be aggregated or summarized by the ranking model 112 to generate a total ranking for the equipment 104. In some embodiments, the ranking may be adjusted based on the criticality of a particular equipment or subsystem to the current operational state of the processing facility 102. For example, the ranking model 112 may apply an adjustment to the health status ranking based on the criticality of the unit of equipment, or subsystem including multiple units of equipment, to the operation of the processing facility 102. In this manner, the ranking model 112 may adjust the rankings to accommodate the current operating state of the processing facility 102.

In some embodiments, the facility health manager 108 may generate a recommendation for the processing facility 102. The recommendation may include any type of recommendation. For example, the recommendation may include a recommendation to implement a maintenance action. In some examples, the recommendation may include a recommendation to adjust an operating parameter of one or more units of equipment 104.

The facility health manager 108 may provide the recommendation to the operations and maintenance manager 106. The operations and maintenance manager 106 may implement the recommendation or cause the recommendation to be implemented. For example, when the recommendation includes a change to an operating parameter of the equipment 104, the operations and maintenance manager 106 may cause the change in operating parameter to be implemented by changing the operating parameter. When the recommendation includes a maintenance action, the operations and maintenance manager 106 may cause the preventative maintenance schedule or corrective maintenance schedule to be updated with the maintenance action.

In some embodiments, the operations and maintenance manager 106 may automatically, and without user input, cause the recommendation to be implemented. In some embodiments, the operations and maintenance manager 106 may provide the recommendation to an operator, and the operator may cause the recommendation to be implemented.

In some embodiments, after the recommendation has been implemented, the facility health manager 108 may receive updated status information for the processing facility 102. For example, the facility health manager 108 may receive updated sensor measurements, reports, and other status information related to the operating state of the processing facility 102. Using the status information, the KPI model 110 may generate KPIs, and the ranking model 112 may generate a new health status ranking for the equipment 104. The new health status ranking may be different for one or more units of equipment. This may result in a new recommendation, which may be implemented, resulting in additional KPIs, rankings, and recommendations. In this manner, the facility health management system 100 may generate a feedback loop between the processing facility 102, the facility health manager 108, and the operations and maintenance manager 106. In this manner, the facility health management system 100 may facilitate improved monitoring and management of the processing facility 102.

In accordance with at least one embodiment of the present disclosure, the facility health management system 100 may incorporate one or more machine learning models. The machine learning models may be used to fine-tune one or more elements of the workflows discussed herein. For example, the machine learning model may be used to fine-tune the KPIs, the health status rankings, the recommendations, other elements of the facility health manager 108, or other elements of the facility health management system 100. As discussed in further detail herein, the machine learning model may be trained based on status information, KPIs, weights, health status rankings, recommendations, changes in status information, KPIs, weights, health status rankings, and recommendations, and other elements of the facility health management system 100. In this manner, the machine learning model or models may improve the identification of rankings and/or recommendations to improve the operation of the processing facility 102.

In some embodiments, a user or an operator may interact with the elements of the facility health management system 100 via a user device 114 over a network 116. For example, the user may receive status information, KPIs, weights, rankings, and recommendations from the elements of the facility health management system 100 over the network 116. In some embodiments, the other elements of the facility health management system 100 may be in direct communication with each other, or may be in communication over the network 116.

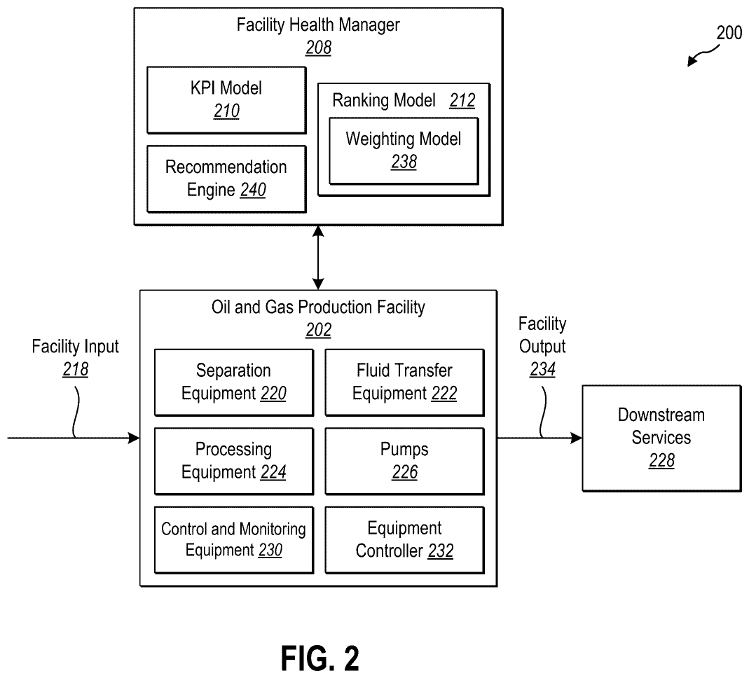

FIG. 2 is a schematic representation of a facility health management system 200, according to at least one embodiment of the present disclosure. In the facility health management system 200, a fluid processing facility 202 (also referred to herein as a processing facility 202) may receive a facility input 218. The facility input 218 may originate from a wellsite. For example, a wellsite may include one or more wells that produce a crude oil stream. In some embodiments, the facility input 218 may be acquired from a collection facility that may collect the crude oil from one or more wells that are remote from each other.

The facility input 218 may include crude oil. For example, the facility input 218 may include unprocessed oil as received from the well. In some examples, the crude oil may be at least partially processed with one or more chemical additives to improve the processing and transportation of the crude oil, such as certain paraffin inhibitors, scale inhibitors, anti-agglomerant hydrate inhibitors, or other inhibitors that may facilitate the transportation of the crude oil from the well to the processing facility 202. In some embodiments, the facility input 218 may include a gas input. For example, the wellsite may include a natural gas well and transmit the natural gas to the production facility. In some embodiments, the facility input 218 may include a combination of oil and gas. In some embodiments, the facility input 218 may be at least partially processed. For example, the facility input 218 may be a gas stream including hydrocarbon gas that has been separated from a crude oil.

The processing facility 202 may process the facility input 218 using one or more of the equipment discussed herein. It should be understood that the equipment discussed with respect to the processing facility 202 are exemplary facility equipment, and that a processing facility 202 may include any combination of one or more of the equipment discussed herein, with specific equipment included or excluded based on the layout of the processing facility 202 and the anticipated composition of the facility input 218.

In accordance with at least one embodiment of the present disclosure, the processing facility 202 may include separation equipment 220 that may separate the components of the facility input 218. For example, the separation equipment 220 may separate the oil and water phases of the facility input 218, extract gas from the facility input 218, extract solids from the facility input 218, or otherwise separate components from the facility input 218 based on the composition of the facility input 218 and the other equipment in the processing facility 202. In some examples, the separation equipment 220 may separate a natural gas throughput into different gasses, such as methane, ethane, propane, and so forth.

The processing facility 202 may further include one or more fluid transfer equipment 222. The fluid transfer equipment 222 may include any equipment that may facilitate the transfer of fluid between components of the processing facility 202 and/or to other facilities. For example, the fluid transfer equipment 222 may include compressors, pumps, valves, piping, and so forth. As a specific, non-limiting example, the fluid transfer equipment 222 may include compressors that receive a gas portion of the facility input 218 and compress the gas portion for transportation, storage, or other processing. In some embodiments, the fluid transfer equipment 222 may be arranged in series, with different fluid transfer equipment 222 increasing the pressure incrementally to a target pressure. In some embodiments, the fluid transfer equipment 222 may be arranged in parallel. In some embodiments, the fluid transfer equipment 222 may include one or more compressor sets. A compressor set may include a set of compressors that are arranged in series or in parallel to process a certain throughput of gas. For example, a compressor set may include two or more compressors in series to compress the throughput of gas to the target pressure. Multiple compressor sets may be arranged in parallel to increase the total throughput of gas processed by the fluid transfer equipment 222. In some embodiments, the fluid transfer equipment 222 may include or be associated with a gas pipeline pumping station.

The processing facility 202 may further include processing equipment 224. The processing equipment 224 may include any type of processing equipment. For example, the processing equipment 224 may include equipment that alters the quality and/or concentration of individual components, including purification and filtration equipment. The processing equipment 224 may further including heating and cooling equipment, or equipment that may alter the operating parameters of the processed fluids and gasses. In some embodiments, the processing equipment 224 may include removal systems for various gasses, such as sulfur dioxide, carbon dioxide, carbon monoxide, oxygen, nitrogen, or other gasses.

The processing facility 202 may further include one or more pumps 226 in addition to or as part of the fluid transfer equipment 222. The pumps 226 may pump fluid around the processing facility 202 and/or out of the processing facility 202 to various downstream services 228. In some embodiments, the pumps 226 may be liquid pumps configured or designed to pump liquids, including liquid oil, gas, or a combination of liquid oil and gas. In some embodiments the pumps 226 may be configured to pump gas, including blowers, fans, compressors, or other elements configured to facilitate transportation of gas in the processing facility 202 and/or to the downstream services 228.

The processing facility 202 may include control and monitoring equipment 230. The control and monitoring equipment 230 may facilitate the observation and control of various elements of the processing facility 202. For example, the control and monitoring equipment 230 may include sensors that may sense the status of the various equipment of the processing facility 202, including input parameters, operating parameters, pressures, temperatures, chemical composition, flow rates, and so forth.

An equipment controller 232 may be in communication with the equipment of the processing facility 202. The equipment controller 232 may control changes to operating parameters of the equipment. For example, the equipment controller 232 may turn on equipment, turn off equipment, change motor settings, open and close valves, change temperatures, control any other aspect of the equipment, and combinations thereof.

The processing facility 202 may process the facility input 218 and generate a facility output 234. The facility output 234 may be directed to the various downstream services 228. The various downstream services 228 may include any type of downstream service, such as a refinery, a power plant, directly to consumers, any other various downstream service 228, and combinations thereof. In some embodiments, excess gas, or gas that is unable to be processed by the processing facility 202, may be burnt off at a flare 236.

In accordance with at least one embodiment of the present disclosure, a facility health manager 208 may receive status information and prepare a ranking of the equipment of the processing facility 202. As discussed herein, status information from the processing facility 202 may include at least one of time-series data, daily reports, maintenance records, inspection records, equipment runtime, equipment uptime, control room reports, shift reports, laboratory samples, any other status information, and combinations thereof.

In some embodiments, a KPI model 210 may, using the status information to generate KPIs for the processing facility 202. For example, the KPI model 210 may generate KPIs associated with the operation of the various units of equipment of the processing facility 202. A non-limiting list of example KPIs may include days since last corrective maintenance action, high importance corrective maintenance action count, planned corrective action count, average time spent in corrective maintenance status (e.g., uptime/downtime, including over the lifetime of the equipment and/or over a specific period of time), total count of corrective maintenance action (including over the lifetime of the equipment and/or over a specific period of time), days since last preventative maintenance action, average time spent in preventative maintenance status (e.g., uptime/downtime, including over the lifetime of the equipment and/or over a specific period of time), total count of preventative maintenance actions (including over the lifetime of the equipment and/or over a specific period of time), facility alerts, alert count (including over the lifetime of the processing plant and/or over a specific period of time), a percent of time in high alert threshold (including over the lifetime of the processing plant and/or over a specific period of time), identified equipment anomalies, time-weighted anomaly state, estimated equipment failure probability, any other KPIs, and combinations thereof, including inclusions or exclusions of any of the foregoing.

In some embodiments, the KPI model 210 may organize the KPIs within certain KPI categories. For example, the KPI model 210 may generate KPI categories associated with corrective maintenance, preventative maintenance, facility alerts, and model-based KPIs. Corrective maintenance KPIs may be associated with corrective maintenance actions, or maintenance actions associated with correcting a faulty or failing unit of equipment. Preventative maintenance KPIs may be associated with scheduled preventative maintenance actions used to maintain equipment in an operating condition.

Alert KPIs may be associated with facility-level alerts, including production alerts, alerts associated with the facility input 218 and/or facility output 234, or other alerts. In some embodiments, alert KPIs may be associated with equipment-level alerts, such as temperature, pressure, motor speed, electricity consumption, or other equipment-level alerts. In some embodiments, the alerts may include operational alerts, which may include pressure alerts, (e.g., a pressure level upstream of a compressor is lower than a threshold value) temperature alerts (e.g., an inlet temperature at an oil vessel is higher than a threshold), and/or flow rate alerts. In some embodiments, the alerts may include product quality alerts, which may include product composition alerts (e.g., the treated crude basic sediment and water (BSW) level exceeds a threshold, the product gas stream carbon dioxide content exceeds a target concentration threshold, hydrogen sulfur content alerts). In some embodiments, the alerts may include maintenance alerts, which may include overdue work orders on a particular unit of equipment, number of corrective maintenance work orders over a time frame for a particular unit of equipment, or a percent of open work orders of a particular unit of equipment. In some embodiments, the alerts may include modelling based alerts, which may include alerts based on modelling of operational lifetime of equipment (e.g., a reduction in the useful life calculations of a carbon dioxide removal membrane within a time period, a heat exchanger health indicator shows increased fouling factor predictions in look ahead window, a compressor risk index shows increased risk probability on account of higher vibrations over a period of time. In some embodiments, the alerts may include safety alerts (e.g., fire or smoke detection, emergency shutdown activation).

In some embodiments, model-based KPIs may be based on one or more models used in the processing facility 202. For example, a model may include a machine learning model into which equipment operating information may be applied. Such a machine learning model may identify steady-state operation of equipment. The machine learning model may further identify operating conditions that differ from the steady-state operation, including operational anomalies in the operation of the equipment, failure probabilities, equipment inefficiencies, and so forth. In some embodiments, the machine learning model may be applied to each individual unit of equipment. In some embodiments, the machine learning model may be applied to multiple units of equipment to identify how the operation of different units of equipment impact each other. In some embodiments, model-based KPIs may incorporate other models. For example, many processing facilities may incorporate simulation models, physics-based models, and other models to identify the operating state of one or more units of equipment in the processing facility 202, which may output status information that may be used as a KPI. While model-based KPIs are listed as a separate category of KPIs, it should be understood that a model, including a machine-learning model, may be applied to generate one or more of the other KPIs discussed herein. In some embodiments, model-based KPIs may include the use of a model to analyze other KPIs. For example, a generative AI model may receive the KPIs as an input and provide an assessment of equipment risks or other risks to facilitate the ranking of the KPIs.

In some embodiments, the KPIs may include production-based KPIs, such as total inflow (e.g., associated with the facility input 218), composition of the facility input 218, additives to the facility input 218, processing history of the facility input 218, total production (e.g., associated with the facility output 234), production types, flare information, and so forth. In some embodiments, the KPIs may include environmental KPIs, such as carbon dioxide emissions, amount of gas flared, spills, and so forth. In some embodiments, the KPIs may include health and safety KPIs, such as lost-time injury reports, atmospheric composition, worker health, worker wellbeing, and so forth. In some embodiments, the KPIs may include employee information, such as employee count, employee experience, shift size, shift identification, employee hours, and so forth. Other examples of KPIs may include a production flow rate, temperature at various locations throughout the processing facility 202, pressure at various locations throughout the processing facility 202, facility uptime (e.g., the percentage of time the processing facility is in active production), production quality (e.g., composition-based KPIs related to the composition of impurities at various areas of the processing facility 202), energy expenditure of various equipment, carbon dioxide footprint, performance-based KPIs (such as efficiency metrics), economic impact KPIs (e.g., loss of production revenue due to downtime, maintenance and repair costs, energy consumption, operating expenses), environmental and regulatory KPIs (emission limits, spills or discharges of hazardous materials, per contractual agreement and local laws), process interdependency KPIs (e.g., processes that feed critical units, units that affect production quality and rate), any other KPIs, and combinations thereof.

In some embodiments, the processing facility 202 may be organized into one or more systems, subsystems, flows, or other groupings of equipment that may be used to perform discrete tasks within the processing facility 202. As a specific, non-limiting example, a subsystem may include a bank of compressors organized to compress a natural gas to a target pressure. Other subsystems may include purification equipment, which may include a combination of compressors, adsorbents, absorbents, separators, and other equipment configured to purify an oil or gas stream. In some embodiments, a subsystem may include its own set of KPIs, and each unit of equipment in the subsystem may include its own set of KPIs.

The facility health manager 208 may further include a ranking model 212. The ranking model 212 may generate a health status ranking for the units of equipment (and/or subsystems) based on the KPIs. The health status ranking may include an indication of the criticality of the unit of equipment (and/or subsystem) to the operation of the processing facility 202. For example, the health status ranking may include an indication of how likely a particular unit of equipment and/or subsystem may be to cause a disruption to the production of the processing facility 202.

As discussed herein, the health status ranking may be a relative ranking between the equipment and/or subsystems of the processing facility 202. For example, the ranking may provide an indication of which equipment in the processing facility 202 may be more likely than the other equipment of the processing facility 202 to disrupt operations of the processing facility 202.

The ranking model 212 may generate a health status ranking that compares dissimilar equipment. For example, the ranking model 212 may generate the health status ranking that compares the impact of equipment that includes different parts, different operating parameters, different operating conditions, different inputs, different outputs, and other different elements. As a specific, non-limiting example, the health status ranking may allow a comparison between a compressor 222 and oil and gas separation equipment 220.

The ranking model 212 may further include a weighting model 238. The weighting model 238 may apply a weight to each of the KPIs. The weighted KPIs may be combined to form the health status ranking. For example, the weighted KPIs may have a numerical value associated with them. The numerical values may be summed, averaged, or otherwise combined to form the health status ranking.

The weighting model 238 may assign a weight to the KPIs in any manner. For example, the weighting model 238 may assign the weight to the KPIs using a pairwise comparison. A pairwise comparison may include a relative ranking between pairs of KPIs. Multiple pairs of KPIs may be ranked or compared to determine which has a greater impact on the productivity of the processing facility 202. The relative rankings of multiple pairs of KPIs may then be used to generate the weight of the health status rankings. In some embodiments, the weighting model may utilize an analytic hierarchy process (AHP). AHP is a structured decision-making framework used for complex, multi-criteria decision problems. It helps prioritize and select the best option by breaking down a decision into a hierarchy of criteria, comparing them pairwise, and assigning weights based on their relative importance.

In some embodiments, the pairwise comparison may be performed based on operator input. For example, an operator of the processing facility 202 may be presented with two different KPIs, and the operator may identify which of the KPIs is more important or critical to the operation of the processing facility 202. The operator may do this for multiple pairs of KPIs. In some embodiments, the operator may perform a pairwise comparison for all of the available KPI pairs.

In some embodiments, the operator may make the pairwise comparison based on different operating states. For example, different operating states of the processing facility 202 may utilize different equipment, have different inputs or outputs, or otherwise have different operating parameters. The operator may perform the pairwise comparison based on the operating state. In this manner, the KPIs may change based on the operating state of the processing facility 202. This may reflect the changing importance of equipment or status information based on the operating state of the processing facility 202.

In some embodiments, the weighting model 238 include a machine learning model. For example, a machine learning model may be trained on status information, KPIs, and other operating state information to the processing facility 202 over time. For example, the weighting model 238 may be trained on the impact of status information, the calculated KPIs, and how changes to the status information and the KPIs over time impact the operation of the processing facility 202. The machine learning model may associate the changes to the status information and KPIs with the operation of the processing facility 202, and assign weights accordingly.

In some embodiments, the weighting model 238 may be trained to fine-tune the weights assigned to the KPIs. For example, the weighting model 238 may identify changes to the operation of the processing facility 202 based on the KPIs, and adjust the weights of the KPIs based on the decisions and the results of the changes.

In accordance with at least one embodiment of the present disclosure, the facility health manager 208 includes a recommendation engine 240. The recommendation engine 240 may generate one or more recommendations for implementation at the processing facility 202. The recommendation may be based on the health status rankings. For example, the recommendation may include a recommendation to implement a maintenance action on a particular unit of equipment. The unit of equipment may be identified based on the unit having the health status ranking that is highest, or the health status ranking that is associated with the unit of equipment having the largest potential impact on the operation of the processing facility 202. In some embodiments, the maintenance action recommendation may include a recommendation to adjust a preventative maintenance schedule for that unit of equipment. In some embodiments, the maintenance action recommendation may include a recommendation to implement a corrective maintenance action for that unit of equipment. In some embodiments, the maintenance action recommendation may include a recommendation to perform a particular type of maintenance, such as an oil change, part replacement, cleaning, calibration, any other maintenance action, and combinations thereof.

In some embodiments, the recommendation may include a recommendation to adjust one or more operating parameters of one of the units of equipment. For example, the recommendation may include a recommendation to adjust a motor setting, a pressure, a valve position, turn on equipment, turn off equipment, or otherwise adjust an operating parameter. In some embodiments, the recommendation may include a recommendation to load-balance different units of equipment to at least partially offload a particular unit of equipment. In this manner, the recommendation may facilitate improved efficiency of operation of the processing facility 202.

The recommendation engine 240 may generate a recommendation in any manner. For example, the recommendation engine 240 may include input from an operator about an action to perform at the processing facility 202. In some examples, the recommendation engine 240 may provide a list to an operator of available actions that may be performed based on the identified unit of equipment. In some examples, the recommendation engine 240 may include a machine learning model that has been trained on health status rankings, prior actions taken, and the results of those actions.

In some embodiments, the facility health management system 200 may implement the recommended action. For example, an operator may instruct the equipment controller 232 to change the operating condition. In some examples, the operator may adjust a maintenance docket or schedule based on the recommendation. In some examples, the operator may instruct the equipment controller 232 to adjust the operating parameters of one of the units of equipment.

In some embodiments, the facility health management system 200 may automatically implement the recommendation. For example, the recommendation engine 240 may instruct the equipment controller 232 to adjust the operating parameters of the equipment. In some examples, the recommendation engine 240 may automatically change the maintenance schedule based on the recommendation. In this manner, the facility health management system 200 may implement an autonomous or semi-autonomous feedback and control loop for operation and maintenance of the facility health management system 200.

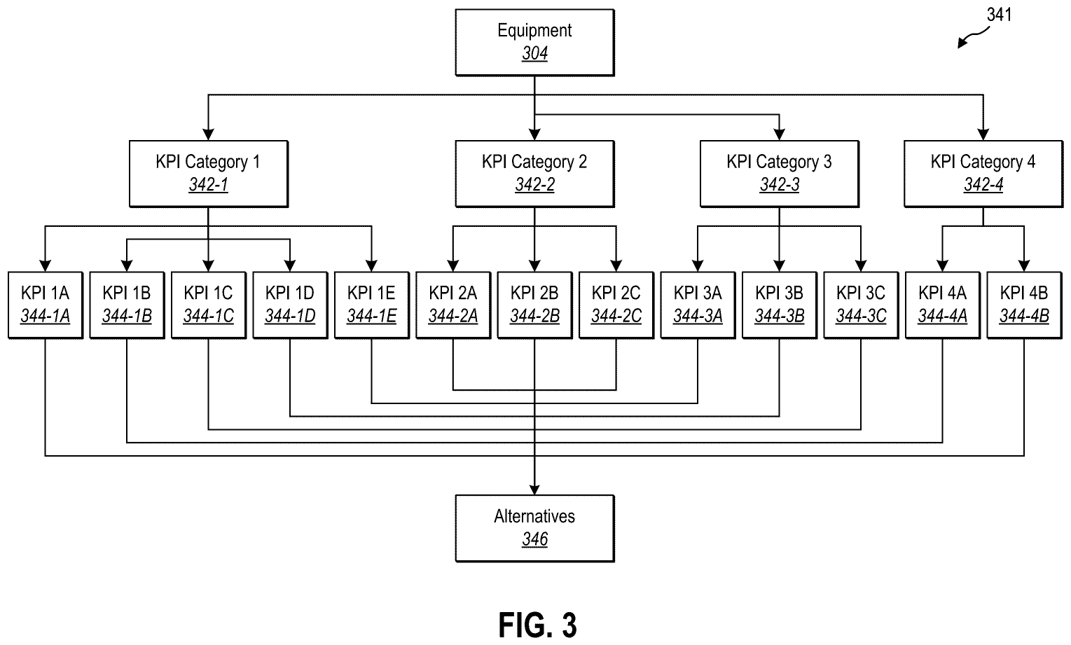

FIG. 3 is a schematic representation of an equipment ranking system 341, according to at least one embodiment of the present disclosure. The equipment ranking system 341 may be generated to assign a health status ranking to a unit of equipment 304. In some embodiments, the equipment ranking system 341 may be used to assign a health status ranking to a single unit of equipment 304. In some embodiments, the equipment ranking system 341 may be used to assign a health status ranking to multiple units of equipment. In some embodiments, the equipment ranking system 341 may be used to assign a health status ranking to each unit of equipment at a processing facility. In some embodiments, the equipment ranking system 341 may be used to assign a health status ranking for a particular system or subsystem. The equipment ranking system 341 may be generated by the facility health manager 208 described with respect to FIG. 2.

For a unit of equipment 304, the facility health manager may generate one or more KPIs. As discussed herein, the KPIs may be separated or categorized into one or more KPI categories (collectively 342). The KPI categories 342 may further include one or more KPIs (collectively 344). As discussed herein, the KPIs 344 may be combined to form a health status ranking. The health status ranking may be generated in comparison or based on one or more alternatives 346. The alternatives 346 may include units of equipment in parallel with the equipment 304, backup units of equipment, or alternative equipment that may be different from, but capable of performing the function of, the equipment 304.

In the embodiment shown, the equipment ranking system 341 is illustrated with 4 nodes or layers (e.g., the equipment 304, the KPI categories 342, the KPIs 344, and the alternatives 346). However, it should be understood that the equipment ranking system 341 may be generated with more or fewer nodes or layers. For example, the equipment ranking system 341 may be generated with additional KPI categories 342, such as a KPI category 342 that includes two or more sub-KPI categories 342. In some examples, a KPI 344 may be formed from or generated by two or more different KPIs. In some examples, the equipment 304 may include a system or subsystem of a facility, and the equipment ranking system 341 may include multiple units of equipment 304 to generate a health status ranking for the system or subsystem.

The equipment 304 may include any equipment used at a processing facility. As a specific, non-limiting example, the equipment 304 may be a compressor, however, it should be understood that any equipment at a processing facility may have a health status ranking assigned based on the equipment ranking system 341. As discussed in further detail herein, the KPI categories 342 may be representative of various categories of KPIs associated with the operation and maintenance of the equipment 304. In the embodiment shown, the equipment ranking system 341 includes four KPI categories 342, including a first KPI category 342-1, a second KPI category 342-2, a third KPI category 342-3, and a fourth KPI category 342-4. However, it should be understood that more or fewer KPI categories 342 may be utilized to generate the health status ranking.

Each of the KPI categories 342 may include associated KPIs 344. For example, a particular KPI category 342 may include KPIs 344 that are associated with that KPI. In the embodiment shown, the first KPI category 342-1 is associated with five KPIs 344 (e.g., a KPI 1A 344-1A, KPI 1B 344-1B, KPI 1C 344-1C, KPI 1D 344-1D, and KPI 1E 344-1E), the second KPI category 342-2 is associated with three KPIs 344 (e.g., a KPI 2A 344-2A, KPI 2B 344-2B, KPI 2C 344-2C), the third KPI category 342-3 is associated with three KPIs 344 (e.g., a KPI 3A 344-3A, KPI 3B 344-3B, KPI 3C 344-3C), and the fourth KPI category 342-4 is associated with two KPIs 344 (e.g., a KPI 4A 344-4A, KPI 4B 344-4B). Thus, as may be seen, the different KPI categories 342 may have any combination of KPIs 344, including two or more KPI categories 342 having the same number of KPIs 344 and different KPI categories 342 having different numbers of KPIs 344. It should be understood that the KPI categories 342 may include any number of KPIs 344, including the KPIs discussed herein.

As discussed herein, a weighting model may assign a weight to each of the KPIs 344. For example, a weighting model may assign a weight to the value or information associated with each of the KPIs 344. The weighting model may include a pairwise comparison. In some embodiments, the pairwise comparison may compare pairs of KPIs 344 in the same KPI category 342. For example, the first KPI category 342-1 shown includes five KPIs 344, and the pairwise comparison may include 10 unique combinations of pairs to assign a weight to the KPIs 344. In some embodiments, the pairwise comparison may compare pairs of KPIs 344 among different categories. In some embodiments, the pairwise comparison may compare KPI categories 342 to each other. In this manner, the health status ranking may be based at least in part on the content of the KPIs 344 and the KPI category 342.

The weighted KPIs 344 may be combined and compared to one or more alternatives 346. For example, the weighted KPIs may be analyzed and compared to identify which of the equipment 304 and the alternatives 346 has a highest ranking and generate an associated recommendation. An illustrative sample output of the equipment ranking system 341 is illustrated below in Table 1.

TABLE 1

| | Weight | Equipment 304 | Alternative 346 |
|---|---|---|---|
| Total Ranking | 100% | 55% | 45% |
| KPI Category 1 342-1 | 60% | 30% | 25% |
| KPI 1A 344-1A | 35% | 20% | 20% |
| KPI 1B 344-1B | 25% | 10% | 5% |
| KPI Category 2 342-2 | 40% | 25% | 20% |
| KPI 2A 344-2A | 40% | 25% | 20% |

As may be seen, the health status ranking assigned to the equipment 304 is 55%, and the one or more alternatives 346 is 45%. As discussed herein, the health status ranking may be a relative ranking, indicating the relative health of the equipment 304 with respect to the alternative 346. The first KPI category 342-1 may have a 60% weight, with the KPI 1A 344-1A having a 35% weight and the KPI 1B 344-1B having a 25% weight. The second KPI category 342-2 has a 40% weight, with the single KPI 2A 244-2A having the same 40% weight. The weight may be applied to the KPIs resulting in the individual portions of the weights for the KPIs 344 and KPI categories shown, and the total ranking. As may be seen, the equipment 304 has a higher ranking than the one or more alternatives 346. As discussed herein, a recommendation engine may generate a recommendation based on the relative rankings between the equipment 304 and the one or more alternatives 346.

While the embodiment described with respect to Table 1 has been describe as between a single equipment 304 and alternative 346, it should be understood that the techniques of the present disclosure may be applied to additional alternatives 346. Indeed, as discussed herein, the techniques of the present disclosure may be applied to compare the equipment 304 to other equipment in a facility to identify the relative rankings between disparate and/or dissimilar units of equipment.

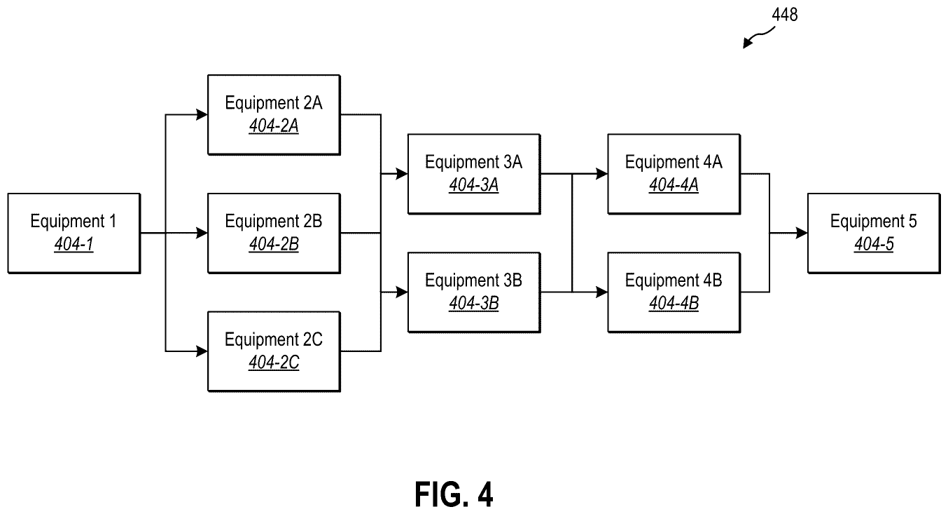

FIG. 4 is a representation of a subsystem 448 of a facility including a flow between multiple units of equipment (collectively 404), according to at least one embodiment of the present disclosure. The subsystem 448 illustrated is a simplified representative of the equipment and production flows of fluids or other materials through a subsystem of a fluid facility.

The subsystem 448 illustrates a fluid flow from a first equipment 404-1, to a set of second equipment (collectively 404-2) arranged in parallel, to a set of third equipment (collectively 404-3) arranged in parallel, to a set of fourth equipment (collectively 404-4) arranged in parallel, and to a fifth equipment 404-5. The first equipment 404-1 and the fifth equipment 404-5 may be capable of processing 100% of the fluid flow. The second equipment 404-2 (including the equipment 2A 404-2A, the equipment 2B 404-2B, and the equipment 2C 404-2C) may each individually process 50% of the fluid flow through the subsystem 448. The third equipment 404-3 (including equipment 3A 404-3A and the equipment 3B 404-3B) may each individually process 75% of the fluid flow through the subsystem 448. The fourth equipment 404-4 (including equipment 4A 404-4A and the equipment 4B 404-4B) may each individually process 100% of the fluid flow through the subsystem 448.

The criticality of the equipment 404 to the operation of the subsystem 448 (and therefore the operation of the processing facility) may be at least partially determined based on the capacity of the equipment 404 to process the fluid flow. Because the first equipment 404-1 and the fifth equipment 404-5 both have a single unit of equipment processing the entirety of the fluid flow, their criticality may be high. Because the third equipment 404-3 has 75% capacity of both units of equipment, if one unit of equipment goes down, at least a portion of the fluid flow may be processed, the criticality may be medium-high. Because the second equipment 404-2 and the fourth equipment 404-4 may each process 100% of the fluid flow using less than all of the equipment, their criticality may be medium-low or low.

Other aspects of criticality may further be determined. For example, criticality may be determined based on the risk of downtime, the effort needed to reduce the equipment risk by 75%, the action taken to mitigate the risk, and the risk of downtime after the action is taken.

The weight of the various KPIs associated with the equipment 404 may be assigned at least in part based on the criticality of the equipment. For example, the weight of the risk of downtime may be increased for equipment 404 that processes the entirety of the fluid flow without any spare equipment. An illustrative example of a table outlining the risk of the subsystem 448 and the associated equipment is provided below in Table 2.

| | | | | |
|---|---|---|---|---|
| | | Effort to | | Downtime |
| | Risk of | reduce | Action | Risk after |
| Equipment | Downtime | risk | taken | action |

1
2A
2B
2C
3A
3B
4A
4B
5
Risk,
Production <100%
Risk,
Production <80%

As discussed herein, the ranking for the equipment may be assigned based at least in part on the risks identified in Table 2. In some embodiments, Table 2 may be used to generate a subsystem rank. For example, the entire subsystem 448 may have a subsystem rank that is based on the ranks of the associated units of equipment and their associated ranks, and the risk associated with the subsystem.

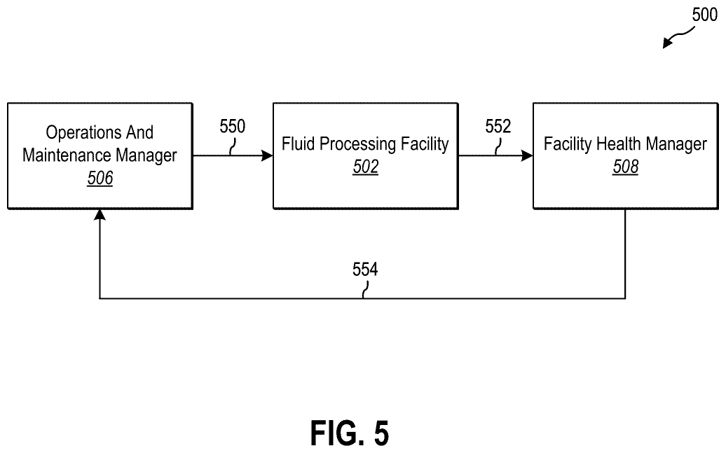

FIG. 5 is a representation of a flow diagram of a facility health management system 500, according to at least one embodiment of the present disclosure. An operations and maintenance manager 506 may provide maintenance and control signals 550 to a processing facility 502. The processing facility 502 may include equipment, and the maintenance and control signals 550 may cause a change in the operating parameters and/or maintenance schedule of the equipment.

Operation of the processing facility 502 may be associated with status information. The processing facility 502 may provide the status information 552 to a facility health manager 508. The processing facility 502 may provide the status information 552 to the facility health manager 508 in any manner. For example, the processing facility 502 may provide a representation of the inputs and outputs of the processing facility 502 to the facility health manager 508. In some examples, the processing facility 502 may provide sensor measurements of the operating status of various units of equipment in the processing facility 502 to the facility health manager 508. In some examples, the processing facility 502 may provide maintenance reports to the processing facility 502.

The facility health manager 508 may analyze the status information 550 and generate KPIs based on the status information. The facility health manager 508 may, using the KPIs, apply a ranking to the equipment and/or subsystems in the processing facility 502. In some embodiments, the facility health manager 508 may apply a ranking to a processing facility that is part of a group of processing facilities. The facility health manager 508 may generate a recommendation 554 to implement at the processing facility 502. The operations and maintenance manager 506 may implement the recommendation 554, resulting in a change in the status information 552 of the processing facility 502. The processing facility 502 may send the updated status information 552 to the facility health manager 508. The facility health manager 508 may generate new KPIs and rankings based on the updated status information 552, resulting in a new recommendation 554. In this manner, the facility health management system 500 may generate a feedback or control loop to advise or improve operation of the processing facility 502.

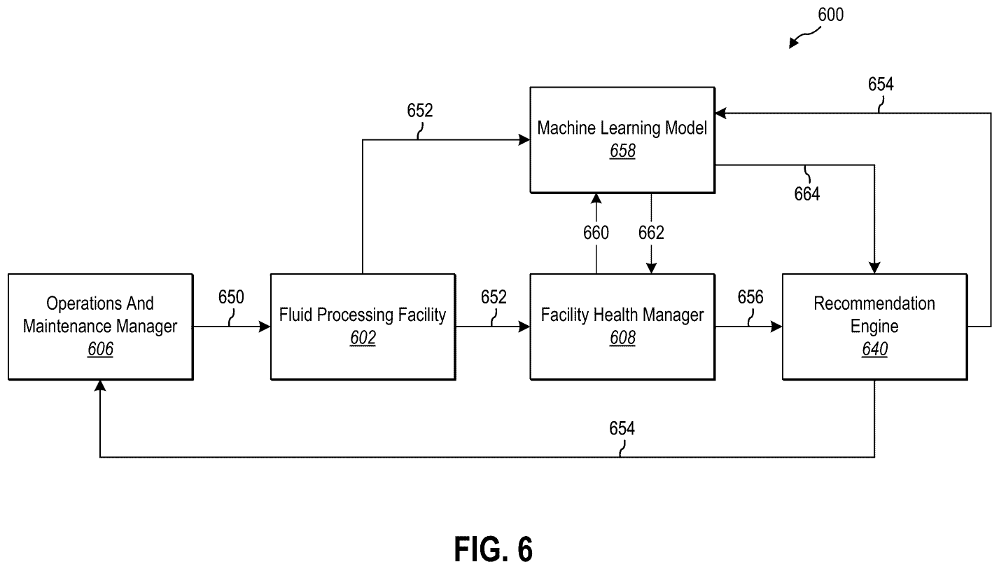

FIG. 6 is a representation of a flow diagram of a facility health management system 600, according to at least one embodiment of the present disclosure. An operations and maintenance manager 606 may provide maintenance and control signals 650 to a processing facility 602. The processing facility 602 may include equipment, and the maintenance and control signals 650 may cause a change in the operating parameters and/or maintenance schedule of the equipment.

The processing facility 602 may provide status information 652 to a facility health manager 608. The facility health manager 608 may analyze the status information 650 and generate KPIs based on the status information. The facility health manager 608 may, using the KPIs, apply a ranking to the equipment and/or subsystems in the processing facility 602. In some embodiments, the facility health manager 608 may apply a ranking to a processing facility that is part of a group of processing facilities.

The predictive control manager 608 may send the rankings 656 to a recommendation engine 640. The recommendation engine 640 may generate a recommendation 654 to implement at the processing facility 602. The operations and maintenance manager 606 may implement the recommendation 654, resulting in a change in the status information 652 of the processing facility 602. The processing facility 602 may send the updated status information 652 to the facility health manager 608. The facility health manager 608 may generate new KPIs and rankings based on the updated status information 652, resulting in a new recommendation 654.

In accordance with at least one embodiment of the present disclosure, the facility health management system 600 may include a machine learning model 658. The machine learning model 658 may analyze data from the facility health management system 600 to identify correlations between the data. This may result in fine-tuned variables and/or models that may improve the ranking of the KPIs and/or recommendations.

In some embodiments, the machine learning model 658 may be trained on historical data. For example, the machine learning model 658 may be trained on historical rankings, historical KPIs, historical weights assigned to the KPIs, and historical recommendations prepared based on the historical rankings, KPIs, and weights.

In some embodiments, the machine learning model 658 may be trained on live data, or may be trained in real time. The machine learning model 658 may receive information from multiple portions of the facility health management system 600. For example, the machine learning model 658 may receive status information 652 from the processing facility 602. The machine learning model 658 may further receive KPI information 660 from the facility health manager 608, and the recommendations 654 from the recommendation engine 640. The machine learning model 658 may provide ranking information 662 to the facility health manager 608. The ranking information 662 may help to fine-tune the rankings of the facility health manager 608. In some embodiments, the machine learning model 658 may provide recommendation information 664 to the recommendation engine 640. The recommendation information 664 may facilitate improved recommendations based on how previous recommendations impacted the status information 652 of the processing facility 602. In this manner, the machine learning model 658 may fine-tune or facilitate improved management or processing of the facility health management system 600.

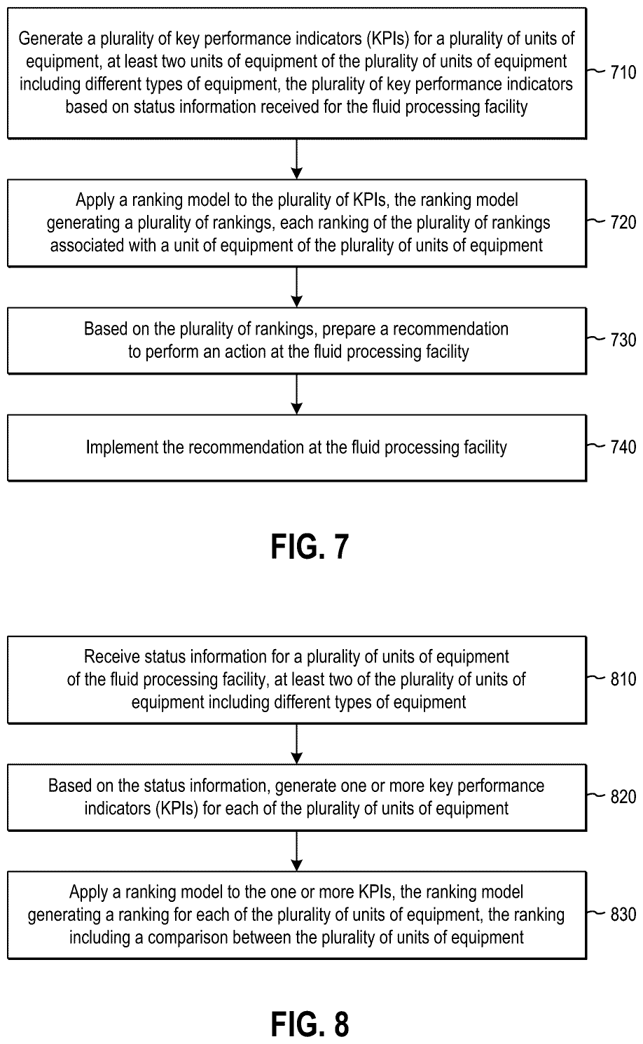

FIG. 7 and FIG. 8, the corresponding text, and the examples provide a number of different methods, systems, devices, and computer-readable media of the facility health management system. In addition to the foregoing, one or more embodiments can also be described in terms of flowcharts comprising acts for accomplishing a particular result, as shown in FIG. 7 and FIG. 8. FIG. 7 and FIG. 8 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts or a method for monitoring a health and a performance of a fluid processing facility, according to at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. Alternatively, a computer-readable medium can comprise instructions that, when executed by one or more processors, cause a computing device to perform the acts of FIG. 7. In some embodiments, a system can perform the acts of FIG. 7.

The facility health management system generates a plurality of key performance indicators (KPIs) for a plurality of units of equipment at 710. At least two units of equipment of the plurality of units of equipment include different types of equipment. The plurality of key performance indicators are based on status information received for the fluid processing facility. The facility health management system applies a ranking model to the plurality of KPIs at 720. The ranking model generates a plurality of rankings. Each ranking of the plurality of rankings is associated with a unit of equipment of the plurality of units of equipment. Based on the plurality of rankings, the facility health management system prepares a recommendation to perform an action at the fluid processing facility at 730. The facility health management system implements the recommendation at the fluid processing facility at 740.

As mentioned, FIG. 8 illustrates a flowchart of a series of acts or a method for monitoring a health and a performance of a fluid processing facility, according to at least one embodiment of the present disclosure. While FIG. 8 illustrates acts according to one embodiment, alternative embodiments may omit, add to, reorder, and/or modify any of the acts shown in FIG. 8. The acts of FIG. 8 can be performed as part of a method. Alternatively, a computer-readable medium can comprise instructions that, when executed by one or more processors, cause a computing device to perform the acts of FIG. 8. In some embodiments, a system can perform the acts of FIG. 8.

A facility health management system may receive status information for a plurality of units of equipment of the fluid processing facility at 810. At least two of the plurality of units of equipment include different types of equipment. The facility health management system, based on the status information, generates one or more key performance indicators (KPIs) for each of the plurality of units of equipment at 820. The facility health management system applies a ranking model to the one or more KPIs at 830. The ranking model generates a ranking for each of the plurality of units of equipment. The ranking includes a comparison between the plurality of units of equipment.

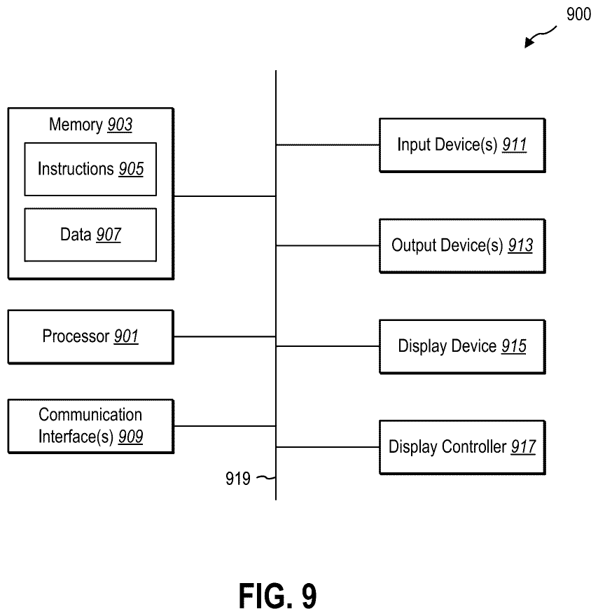

FIG. 9 illustrates certain components that may be included within a computer system 900. One or more computer systems 900 may be used to implement the various devices, components, and systems described herein.

The computer system 900 includes a processor 901. The processor 901 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used.

The computer system 900 also includes memory 903 in electronic communication with the processor 901. The memory 903 may be any electronic component capable of storing electronic information. For example, the memory 903 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 905 and data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during execution of the instructions 905 by the processor 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For the sake of clarity, the various buses are illustrated in FIG. 9 as a bus system 919.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for monitoring a health and a performance of a fluid processing facility, the method comprising:
generating a plurality of key performance indicators (KPIs) for a plurality of units of equipment, at least two units of equipment of the plurality of units of equipment including different types of equipment, the plurality of key performance indicators based on status information received for the fluid processing facility;
applying a ranking model to the plurality of KPIs, the ranking model generating a plurality of rankings, each ranking of the plurality of rankings associated with a unit of equipment of the plurality of units of equipment;
based on the plurality of rankings, preparing a recommendation to perform an action at the fluid processing facility; and
implementing the recommendation at the fluid processing facility.

2. The method of claim 1, further comprising, wherein the recommendation includes a maintenance action.

3. The method of claim 2, wherein the maintenance action includes a change in a preventative maintenance schedule.

4. The method of claim 1, further comprising, after implementing the recommendation, generating a plurality of new KPIs for the plurality of units of equipment, the plurality of new KPIs based on updated status information received for the processing facility.

5. The method of claim 4, wherein applying the ranking model includes applying a machine learning model to the plurality of KPIs, the machine learning model trained to generate a plurality of weights associated with the plurality of KPIs.

6. The method of claim 5, further comprising training the machine learning model based on the plurality of new KPIs and the updated status information.

7. The method of claim 6, wherein training the machine learning model includes fine-tuning the plurality of weights.

8. The method of claim 1, wherein preparing the recommendation includes preparing the recommendation based on which of the plurality of units of equipment has a highest ranking of the plurality of rankings.

9. A method for monitoring a health and a performance of a fluid processing facility, the method comprising:
receiving status information for a plurality of units of equipment of the fluid processing facility, at least two of the plurality of units of equipment including different types of equipment;
based on the status information, generating one or more key performance indicators (KPIs) for each of the plurality of units of equipment; and
applying a ranking model to the one or more KPIs, the ranking model generating a ranking for each of the plurality of units of equipment, the ranking including a comparison between the plurality of units of equipment.

10. The method of claim 9, further comprising, based on the ranking, adjusting at least one operating parameter of at least one of the plurality of units of equipment.

11. The method of claim 9, further comprising, based on the ranking, preparing a recommendation to improve operation of the fluid processing facility.

12. The method of claim 11, further comprising implementing the recommendation.

13. The method of claim 11, wherein the recommendation includes a maintenance action.

14. The method of claim 9, wherein the status information includes sensor data.

15. The method of claim 9, wherein the ranking model includes a machine learning model, trained on prior health statuses for fluid processing facilities.

16. The method of claim 9, wherein the one or more KPIs include a plurality of KPIs, and further comprising applying a weighting model to the plurality of KPIs, the weighting model generating a plurality of weights, each weight of the plurality of weights assigned to an associated KPI of the plurality of KPIs to generate the ranking.

17. The method of claim 16, wherein the weighting model includes a machine learning model trained on historical ranking and historical KPIs.

18. The method of claim 16, wherein applying the weighting model includes changing the ranking based on a criticality of an associated unit of equipment to a current operating state of the fluid processing facility.

19. The method of claim 9, wherein the fluid processing facility includes a plurality of subsystems, each subsystem of the plurality of subsystems including a subset of the plurality of units of equipment, and wherein applying the ranking model includes generating a subsystem rank for each of the plurality of subsystems.

20. A facility health management system, comprising:
a processor and memory, the memory including instructions that cause the processor to:
generate a plurality of key performance indicators (KPIs) for a plurality of units of equipment, at least two units of equipment of the plurality of units of equipment including different types of equipment, the plurality of key performance indicators based on status information received for the fluid processing facility;
apply a ranking model to the plurality of KPIs, the ranking model generating a plurality of rankings, each ranking of the plurality of rankings associated with a unit of equipment of the plurality of units of equipment;
based on the plurality of rankings, prepare a recommendation to perform an action at the fluid processing facility; and
implement the recommendation at the fluid processing facility.
